(19) United States
(12) Patent Application Publication
(10) Pub. No.: US 2024/0052726 A1
(43) Pub. Date: Feb. 15, 2024

(54) METHOD FOR ENHANCED STORAGE OF CARBON DIOXIDE IN GEOLOGICAL FORMATIONS

(71) Applicant: SAUDI ARABIAN OIL COMPANY, Dhahran (SA)

(72) Inventors: Zuhair AlYousif, Saihat (SA); Subhash C. Ayirala, Dhahran (SA); Muhammad M. Almajid, Qatif (SA); Moataz Abu AlSaud, Khobar (SA)

(73) Assignee: SAUDI ARABIAN OIL COMPANY, Dhahran (SA)

(21) Appl. No.: 17/819,531

(22) Filed: Aug. 12, 2022

(51) Int. Cl. E21B 41/00; B65G 5/00

(52) U.S. Cl. CPC E21B 41/0064; B65G 5/00

(57) ABSTRACT

Described is a method for enhanced carbon dioxide (CO₂) sequestration in geological formations. The method includes dissolving CO₂ in a low salinity fluid to form a CO₂-brine solution. The low salinity fluid includes sodium (Na⁺) ions and sulfate (SO₄²⁻) ions. The CO₂-brine solution is injected into a geological formation, and the CO₂ reacts with the geological formation to produce solid carbonate minerals for CO₂ sequestration.

Increasing carbon dioxide (CO₂) emissions poses significant challenges for many governments and industries. Reduction of CO₂ emissions may be approached through two main categories. One category is developing and expanding the utilization of resources that emit less CO₂. The second category is utilization of the already emitted CO₂ for permanent storage underground.

Carbon capture and storage (CCS) has emerged as a solution to counterbalance the greenhouse gas (GHG) emissions. During CCS, the CO₂ in the atmosphere is captured, compressed, transported, and eventually stored underground in geological formations. Geological formations include, but are not limited to, depleted oil and gas reservoirs, coal bed methane reservoirs, deep saline aquifers, and basaltic formations.

CO₂ can be sequestered in geologic formations by four principal mechanisms: structural/stratigraphic trapping, capillary/residual trapping, solubility trapping, and mineral trapping. Safe and secure storage of CO₂ is a requirement of this technology. The effectiveness of sequestering CO₂ into deep reservoirs depends on the reservoir's storage capacity, its stability, and its risk of leakage. Injecting CO₂ into porous basalt rocks has been identified as a process for safe and fast CO₂ storage. Storing CO₂ in basalts is beneficial compared to sequestering CO₂ into deep saline aquifers or depleted oil and gas reservoirs. The benefits are accomplished due to the rapid mineralization of CO₂ into carbonates in basalts relative to that in other formations.

CO₂ sequestration in basalts consists of capturing CO₂ by dissolving it in groundwater or seawater, followed by injecting the CO₂-rich water into basalts. Once dissolved in water, CO₂ is no longer buoyant. The acidity of CO₂-rich water accelerates metal release from Calcium (Ca)-Magnesium (Mg)-Iron (Fe) rich rocks, such as basalt, and formation of solid carbonate minerals. To enhance the efficiency of the mineralization process, CO₂ is co-injected with sufficient water downhole so that the gas is completely dissolved at the depth of its release into the target subsurface basalt.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for enhanced storage of carbon dioxide (CO₂) in geological formations. The method includes dissolving CO₂ in a low salinity fluid to form a CO₂-brine solution. The low salinity fluid includes sodium (Na⁺) ions and sulfate (SO₄²⁻) ions. The CO₂-brine solution is injected into a geological formation, and the CO₂ reacts with the geological formation to produce solid carbonate minerals for CO₂ sequestration.

Other aspects and advantages of the claimed subject matter will be apparent from the following description and the appended claims.

### BRIEF DESCRIPTION OF DRAWINGS

FIG. 1 illustrates injection of CO₂ and water into a geological formation in a CO₂ sequestration process according to some embodiments of the present disclosure.

FIG. 2 illustrates brine composition and salinity for a high salinity water (HSW) solution and three low salinity water (LSW) solutions according to some embodiments of the present disclosure.

FIG. 3 illustrates solubility of CO₂ in a HSW solution compared to a LSW solution according to some embodiments of the present disclosure.

FIG. 4 illustrates a process for enhanced CO₂ sequestration in geological formations according to some embodiments of the present disclosure.

### DETAILED DESCRIPTION

In one aspect, embodiments disclosed herein relate to a method for enhanced storage of carbon dioxide (CO 2) in geological formations, such as reactive basaltic rocks (or basalt).

Basalt contains approximately 25% by weight of calcium (Ca), magnesium (Mg), and iron (Fe) oxides. Basalt is more reactive in water than sedimentary rocks. Therefore, the metals contained in basalts are readily available to combine with injected CO₂ to form carbonate minerals. As noted above, CO₂ is typically dissolved with sufficient water to maintain its solubility at downhole conditions (avoiding negative effects of CO₂ falling out of solution and becoming buoyant in the formation and CO₂ migration to the surface). This may result in an excess of water being used and a decrease in CO₂ sequestration efficiency.

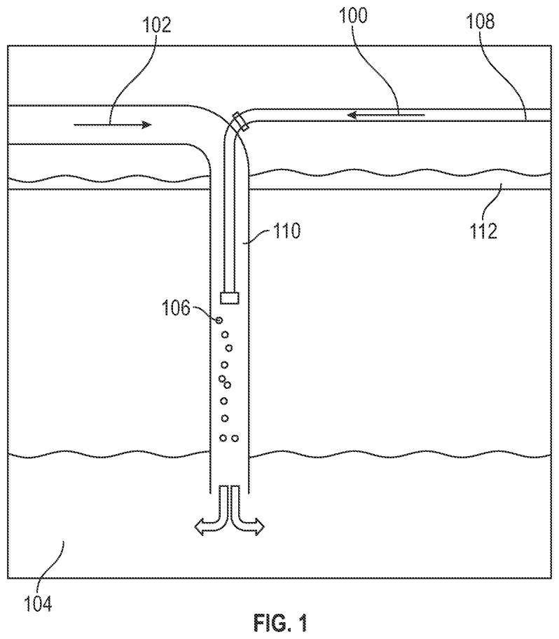

As depicted in FIG. 1, CO₂ (100) that has been captured, compressed, and transported to a well in a geological formation may be dissolved into water (102) (e.g., groundwater, seawater) during its injection into the geological formation (104), such as basalt. CO₂ bubbles (106) may be released from a pipeline (108) at a predetermined depth (e.g., 350 meters) within an injection well (110) and into the water (102) flowing down into the injection well (110). The dissolved CO₂ will not migrate up to the surface (112), because the dissolved CO₂ is not buoyant. The CO₂ rich water may accelerate metal release from basalt. Therefore, formation of solid carbonate minerals may also be accelerated. The storage of the CO₂ as a mineral may immobilize the CO₂ in the geological formation (104). To enhance the efficiency of the mineralization process, CO₂ may be co-injected with a sufficient volume of fluid down the injection well (110), such that the CO₂ gas may be completely dissolved at the depth of its release into the target subsurface basalt. Increasing the amount of the dissolved CO₂ may enhance CO₂ storage in the geological formation (104).

The solubility of CO₂ in water is salinity dependent. As the salinity decreases, the CO₂ solubility increases. Additionally, CO₂ solubility in brine is a function of the total dissolved solids (TDS). TDS is a measure of the dissolved combined content of all inorganic and organic substances present in a liquid.

Different parameters can affect the mineralization process for CO₂ sequestration. As CO₂ dissolves in brine, it decomposes into H⁺ and HCO₃⁻. Mineralization of CO₂ into carbonate minerals occur from a combination of water-carbon dioxide mixtures and divalent metal cations (Ca²⁺, Mg²⁺, Fe²⁺). These cations are present in formation waters but constitute dilute concentrations. Basaltic rocks, however, are rich in these cations and poor in silica. Additionally, basaltic rocks are comprised of minerals that contain these divalent metal cations at far-from-equilibrium states. A far-from-equilibrium state means that the reaction rates occur faster than normal because the ion activity product is far away from the equilibrium constant. This translates into high dissolution rates of these metals compared to other types of rocks.

Bicarbonate is naturally produced by the reaction of CO₂ with water (H₂O) The first step for this rock-fluid interaction is that carbonic acid (H₂CO₃) can dissociate into bicarbonate (HCO₃⁻) and proton (H⁺) ions, lowering the pH of water, as shown in equations (1) and (2) below.

CO₂+H₂O [symbol] H₂CO₃ (1)

H₂CO₃ [symbol] HCO₃⁻(aq)+H⁺(aq). (2)

Divalent metal cations in the water may precipitate as carbonates (Ca, Mg, Fe)CO₃ as follows:

(Ca,Mg,Fe)²⁺(aq)+H₂CO₃→(Ca,Mg,Fe)CO₃(s)+2H⁺(aq). (3)

The reaction in equation (3) occurs if the hydrogen ions are consumed by another reaction. Equations (4) and (5) below present two non-limiting examples of minerals that are commonly present in reactive basalts, including forsterite (Mg₂SiO₄) and plagioclase (CaAl₂Si₂O₈). The consumption of the free hydrogen in the reactions releases new divalent metal cations into the water. The free cations then react with the CO₂-water mixture (see equation (3)) to precipitate as carbonates.

Mg₂SiO₄(s)+4H⁺+(aq)→2Mg²⁺(aq)+H₂O+SiO₂(aq) (4)

CaAl₂Si₂O₈(s)+8H⁺(aq)→Ca²⁺2Al³⁺(aq)+4H₂O+2SiO₂(aq) (5)

Therefore, parameters that control the mineralization include presence of reactive minerals and formation of carbonic acid. Additionally, depth of the geological formation is another parameter. As depth increases, pressure increases and the CO₂ becomes dense. Eventually the solubility of CO₂ in brine is enhanced. Furthermore, temperature is another parameter that affects the mineralization process for CO₂ sequestration. The temperature enhances the reactivity, such that at high temperatures, CO₂ mineralizes faster.

In the past, various water chemistries (brines) have been used to maintain CO₂ solubility during injection into geological formations while promoting carbonate formation. There are various parameters to consider in maintaining CO₂ during injection downhole, such as temperature, pressure, and salt concentrations. It has been determined that a low salinity water (LSW) fluid, more specifically a sulfate containing LSW fluid, may be effective for controlling these factors while increasing CO₂ solubility. Sulfate, or sulfate plus additional aqueous ions, enhances CO2 solubility and may be effectively injected into and react with various basalt formations.

To enhance its solubility, CO₂ may be co-injected into basaltic formations with a low salinity brine fluid having specific aqueous ions according to one or more embodiments of the present disclosure. The low salinity brine fluid may act to increase the amount of the dissolved CO₂, reduce the volume of water used, and expedite mineralization for enhanced CO₂ storage. Furthermore, the formulation of the low salinity solution, such as the type of aqueous ions included and their amounts, may be adjusted based on the target basaltic formation and/or other conditions, as allowing for customization of the injection solution to enhance CO₂ sequestration.

As reported, the solubility of CO₂ is salinity dependent. As salinity decreases, solubility of CO₂ in water increases. Generally, CO₂ solubility in brine decreases as salinity increases due to the so-called “salting out” effect. Comparisons between different salinities reveal that CO₂ solubility decreases nearly 49% when the salinity increases from 0 to 4 mol aqueous NaCl solutions. Given the same temperature and pressure conditions, more CO₂ can be dissolved in low salinity water (LSW) solutions than high salinity water (HSW) solutions. Less water is needed when LSW is used for the same amount of CO₂ available and under the same temperature and pressure conditions. Therefore, the use of a LSW solution is advantageous in an environment with limited water resources and/or to reduce water usage. In addition, when more CO₂ is dissolved in water, the pH of the water decreases. A parameter that enhances the reactivity of carbonated water with rock minerals is the acidity of the water. As a result, it is expected that when more CO₂ is dissolved in water, reactivity and, thus, mineralization may be expedited.

The method according to embodiments of the present disclosure may accelerate formation of solid carbonate minerals compared to existing injection solutions with the use of a specific low salinity solution that increases CO₂ solubility. In other words, use of the low salinity solution may enhance the efficiency of the mineralization process for CO₂ sequestration.

### EXAMPLES

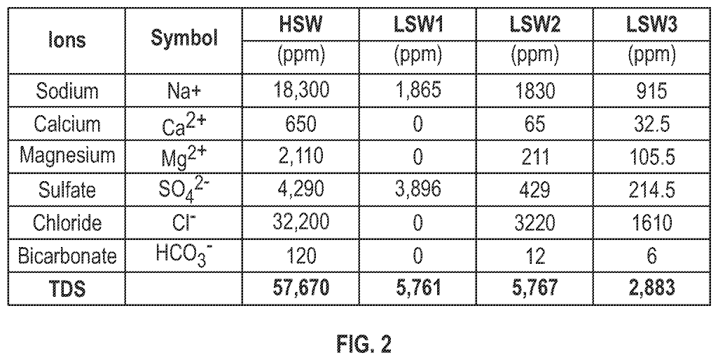

Several brine solutions were used to evaluate the CO₂ solubility in experimental studies. The results of the studies are presented in the table in FIG. 2. The brine solutions evaluated include a high salinity water (HSW) solution and three low salinity water (LSW) solutions (LSW1, LSW2, LSW3). The table shows non-limiting examples of aqueous ions that may be utilized in preparing the LSW solution. As can be appreciated by one skilled in the art, other aqueous ions may also be used as additives to the LSW solution in addition to those listed in FIG. 2.

In one embodiment, the HSW solution contains water and the following ions: sodium (Na⁺), calcium (Ca²⁺), magnesium (Mg²⁺), sulfate (SO₄²⁻), chloride (Cl⁻), and bicarbonate (HCO₃⁻). LSW solution 1 includes only Na⁺ and HCO₃⁻ ions. LSW solution 2 and LSW solution 3 include a combination of Na⁺, HCO₃⁻, Ca²⁺, Mg²⁺, SO₄²⁻, and Cl⁻ in different amounts. The composition of the LSW solutions in FIG. 2 are provided only as examples and are not intended to limit the types or amounts of ions that may be utilized. As shown in FIG. 2, LSW solution 2 has a similar TDS value as LSW solution 1. The TDS value for LSW solution 3 is approximately 50% lower than the TDS of LSW solutions 1 and 2. Each of the LSW solutions presented in FIG. 2 has a TDS value significantly less than the TDS value of the HSW solution. (e.g., 57,670 parts per million (ppm) compared to 5,761 ppm).

In one or more embodiments, the salinity range for the LSW solution is 3,000 to 6,000 ppm TDS. In one or more embodiments, the range of aqueous ions that may be used in preparing the LSW is as follows: sodium ions: 1,000 to 2,000 ppm; calcium ions: 10 to 100 ppm; magnesium ions: 25 to 250 ppm; sulfate ions: 200 to 4,000 ppm, and chloride ions: 1,500 to 3,500 ppm.

As can be appreciated by one skilled in the art, different LSW solutions having different compositions may be implemented depending on the basaltic formation and conditions surrounding the formation. The conversion of CO₂ into carbonate minerals is related to the success of CO₂ storage in basaltic formations. As CO₂ dissolves in brine, it decomposes into H+ and HCO₃⁻. Mineralization of CO₂ into carbonate minerals occurs from a combination of water-CO₂ mixtures and divalent metal cations (e.g., Ca²⁺, Mg²⁺, Fe²⁺). These cations are present in formation waters but are present in dilute concentrations. One or more of these ions may be added in higher concentrations to enhance CO₂ mineralization.

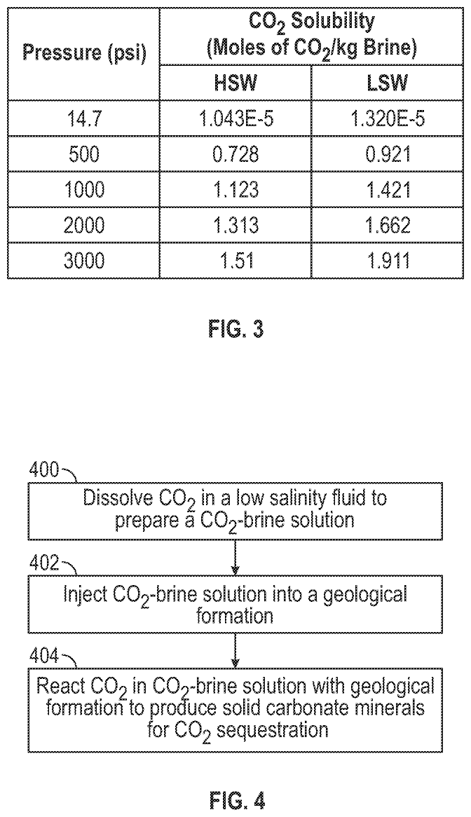

FIG. 3 is a table illustrating computed results from geochemical modeling of CO₂ solubility in brine when an LSW solution is used compared to a HSW solution. The table lists CO₂ solubility values (in moles of CO₂ per kilogram (kg) brine) for an example LSW solution (LSW1 in FIG. 2) and an example HSW solution obtained at different pressures (14.7 psi, 500 psi, 1000 psi, 2000 psi, and 3000 psi). Different pressures were used in the experimental studies to show how pressure significantly affects solubility of CO₂ in water. As pressure increases, density of CO₂ increases as well. The increase in CO₂ density decreases the difference between the water density and the CO₂ density. This decrease in the difference eventually reduces the surface tension between the water and the CO₂. As a result, more CO₂ is expected to be dissolved in water as pressure increases.

The results in FIG. 3 show an increase in CO₂ solubility in brine when the LSW solution is used compared to the HSW solution at all pressures tested. Specifically, the results show a 27% increase in CO₂ solubility when the LSW solution is used. Thus, by changing the salinity of the solution, the solubility of CO₂ may be improved.

In one or more embodiments, the LSW solution may be prepared by adding a desired amount of Na₂SO₄ salt to naturally available fresh water, such as lake water, river water, or reverse osmosis (RO) product water. For example, Na₂SO₄ salt may be added to and mixed with RO product water using specific mixing equipment at a facility near injection wells. Alternatively, shallow aquifer wells may be drilled, and groundwater may be produced and transported to the targeted field. In this embodiment, mixing may occur near the injection wells using specific mixing equipment and facility. Water may be transported via pipelines from any suitable water location to injection wells.

In addition, the LSW solution may be prepared by blending a small volume of sulfate-rich rejected stream (generated from the seawater treatment using nanofiltration) with fresh water. The sulfate ions precipitated from either seawater or produced water based on chemical precipitation methods may also be added to fresh water to prepare the LSW solution and subsequently dissolve larger volumes of CO₂ for injection into basaltic formations. The LSW solution may also be prepared by adding other ions, in any combination, to water as described below.

FIG. 4 is a flow diagram illustrating the method for enhanced CO₂ sequestration in geological formations, such as basalt, according to some embodiments of the present disclosure. In a step (400), a CO₂-brine solution is prepared by dissolving CO₂ in a low salinity fluid. For the purposes of this disclosure, the CO₂-brine solution and the LSW solution refer to the same solution. The CO₂-brine solution is injected into a geological formation, such as basaltic rock, in a step (402). The CO₂-brine solution may be mixed and prepared immediately before injection. In a step (404), the CO₂ in the CO₂-brine solution reacts with the geological formation to produce solid carbonate minerals.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for enhanced carbon dioxide (CO₂) sequestration in geological formations, the method comprising:
dissolving CO₂ in a low salinity fluid to form a CO₂-brine solution;
injecting the CO₂-brine solution into a geological formation; and
reacting the CO₂ with the geological formation to produce solid carbonate minerals, wherein the low salinity fluid comprises sodium (Na⁺) ions in a range of 1,000 to 2,000parts per million (ppm) and sulfate (SO₄²⁻) ions in a range of 200 to 4,000 ppm.

2. The method according to claim 1, wherein the low salinity fluid further comprises calcium (Ca²⁺) ions in a range of 10 to 100 ppm.

3. The method according to claim 2, wherein the low salinity fluid further comprises (Mg²⁺) ions in a range of 25 to 250 ppm.

4. The method according to claim 3, wherein the low salinity fluid further comprises chloride (Cl⁻) ions in a range of 1,500 to 3,500 ppm.

5. The method according to claim 1, wherein the low salinity fluid further comprises magnesium (Mg²⁺) ions in a range of 25 to 250 ppm.

6. The method according to claim 1, wherein the low salinity fluid further comprises chloride (Cl⁻) ions in a range of 1,500 to 3,500 ppm.

7. The method according to claim 1, wherein the geological formation is a basaltic formation.

8. The method according to claim 1, further comprising preparing the low salinity fluid with seawater.

9. The method according to claim 1, further comprising preparing the low salinity fluid with groundwater.
